(19) United States
(12) Patent Application Publication
(10) Pub. No.: US 2025/0097872 A1
(43) Pub. Date: Mar. 20, 2025

(54) METHODS FOR DERIVING PERIODIC RAN NOTIFICATION AREA (RNA) UPDATE TIMER (T380) FOR RRC-INACTIVE UES

(71) Applicant: Rakuten Symphony, Inc., Tokyo (JP)

(72) Inventors: Sridhar BHASKARAN, Banglore (IN); Santhiyaku ANTONYRAJ, Banglore (IN)

(73) Assignee: Rakuten Symphony, Inc., Tokyo (JP)

(21) Appl. No.: 18/012,057

(22) PCT Filed: Nov. 22, 2022
(86) PCT No.: PCT/US2022/050660

§ 371 Date: Dec. 21, 2022

(51) Int. Cl. H04W 60/02

(52) U.S. Cl. CPC H04W 60/02

(57) ABSTRACT

A method, apparatus, and computer-readable recording medium for configuring a periodic radio access network (RAN) notification area (RNA) update timer based on a periodic registration update timer. The method includes: obtaining a periodic registration update timer value provided by a core network; and determining a RNA update timer value based on the obtained periodic registration update timer value such that the RNA update timer value is less than the obtained periodic registration update timer value and less than a predetermined maximum value for the RNA update timer.

### 1. FIELD

Apparatuses and methods consistent with example embodiments of the present disclosure relate to configuring a periodic radio access network (RAN) notification area update timer (e.g., T380) based on a periodic registration update timer provided by the core network.

### 2. DESCRIPTION OF RELATED ART

In related art telecommunications standards (e.g., 3GPP specifications for 5G, etc.), the Radio Resource Control (RRC) protocol defines the signaling exchanged between user equipment (UE) and a base station over the radio interface. The operation of the RRC is guided by a state machine that defines the various RRC states that a UE may be present in. Among them, 3GPP specifies an RRC-Inactive state mechanism (introduced in the 5G standard) where user equipment (UE) context is maintained in the radio access network (RAN) in an inactive (e.g., hibernated) state while the UE is still retained in a Connection Management (CM)-CONNECTED state with the core network.

When the UE is in the RRC-Inactive state, the UE does not inform a change of cell to the RAN as long as the UE is in the RAN Notification Area (RNA) provided to the UE. To this end, the UE performs a periodic RNA update to the RAN based on a periodic RNA update timer (e.g., T380) provided to the UE. The UE also maintains a periodic registration update area timer (e.g., T3512) for performing a periodic registration update procedure towards the core network. The T380 value provided to the UE should not exceed the T3512 value as otherwise the UE may wake up to signal a core network even before the UE wakes up to signal the RAN.

### SUMMARY

According to embodiments, systems and methods are provided for adjusting a periodic radio access network (RAN) notification area update timer (e.g., T380) based on a periodic registration area timer provided by the core network.

According to one or more embodiments, a method, performed by at least one processor, for configuring a periodic radio access network (RAN) notification area (RNA) update timer based on a periodic registration update timer includes obtaining a periodic registration update timer value provided by a core network; and determining a RNA update timer value based on the obtained periodic registration update timer value such that the RNA update timer value is less than the obtained periodic registration update timer value and less than a predetermined maximum value for the RNA update timer.

The determining the RNA update timer value may include: determining a parameter based on the periodic registration update timer; and determining the RNA update timer value based on the parameter and the periodic registration update timer value.

The determining the RNA update timer value may include configuring and/or updating the parameter via an O1 interface between a Service Management and Orchestration (SMO) framework and a centralized unit of a radio access network (RAN).

The determining the parameter may include: receiving, by an xApp of a near-real-time RAN Intelligent Controller (RIC), the periodic registration update timer value; and determining, by the xApp, the parameter based on the received periodic registration update timer value, wherein the determining the RNA update timer value based on the parameter and the periodic registration update timer value may include: receiving, by a centralized unit of a RAN, the parameter from the near-real-time RIC over an E2 interface, and determining, by the centralized unit, the RNA update timer based on the parameter and the periodic registration update timer value.

The determining the parameter may include: determining whether the received periodic registration update timer value is greater than the predetermined maximum value for the RNA update timer; based on the received periodic registration update timer value being greater than the predetermined maximum value for the RNA update timer, determining the parameter to be equal to (the predetermined maximum value for the RNA update timer/the received periodic registration update timer value); and based on the received periodic registration update timer value being less than or equal to the predetermined maximum value for the RNA update timer, determining the parameter to be equal to ((the predetermined maximum value for the RNA update timer−the received periodic registration update timer value)/the predetermined maximum value for the RNA update timer).

The determining, by the centralized unit, the RNA update timer value based on the parameter and the periodic registration update timer value may include determining the RNA update timer value to be equal to (the parameter*the periodic registration update timer value) and rounding it off to a nearest RNA update timer value enumerations as specified in the 3GPP specification.

The RNA update timer value may be determined by an xApp of a near-real-time RAN Intelligent Controller (RIC) using the periodic registration update timer value, and is provided to a centralized unit of a RAN over an E2 interface.

The determining the RNA update timer value may include: determining whether the periodic registration update timer value is greater than the predetermined maximum value for the RNA update timer; based on the periodic registration update timer value being greater than the predetermined maximum value for the RNA update timer, determining the RNA update timer value to be equal to the predetermined maximum value for the RNA update timer; and based on the periodic registration update timer value being less than or equal to the predetermined maximum value for the RNA update timer, determining the RNA update timer value to be equal to (the periodic registration update timer value−(the periodic registration update timer value squared/the predetermined maximum value for the RNA update timer)).

The determining the RNA update timer value may include determining, by the xApp, the RNA update timer value based on an average user equipment (UE) residence time in the RAN.

An average UE residence time in RAN may be calculated in the xApp based on a UE admit time and a UE release time, averaged across a plurality of UEs.

The xApp determines the UE admit time and the UE release time based on the UE admit and release events notified by the centralized unit (over E2).

The determining the RNA update timer value may include determining, by the xApp, the RNA update timer value based on an average downlink inter packet arrival gap in RRC-Inactive state.

The xApp determines the average downlink inter packet arrival gap based on an average time difference between two downlink data indications received for the UE.

An arrival of downlink data indication at the centralized unit (CU) may be indicated to the xApp through the E2 interface.

According to one or more embodiments, an apparatus for configuring a periodic radio access network (RAN) notification area (RNA) update timer based on a periodic registration update timer, the apparatus includes: a memory storing instructions; and at least one processor configured to execute the instructions to: obtain a periodic registration update timer value provided by a core network; and determine a RNA update timer value based on the obtained periodic registration update timer value such that the RNA update timer value is less than the obtained periodic registration update timer value and less than a predetermined maximum value for the RNA update timer.

The at least one processor may be further configured to determine the RNA update timer value further by configuring and/or updating the parameter via an O1 interface between a Service Management and Orchestration (SMO) framework and a centralized unit of a radio access network (RAN).

The at least one processor may be further configured to determine the parameter by: receiving, by an xApp of a near-real-time RAN Intelligent Controller (RIC), the periodic registration update timer value, and determining, by the xApp, the parameter based on the received periodic registration update timer value; and the determining the RNA update timer value based on the parameter and the periodic registration update timer value may include: receiving, by a centralized unit of a RAN, the parameter from the near-real-time RIC over an E2 interface, and determining, by the centralized unit, the RNA update timer based on the parameter and the periodic registration update timer value.

The at least one processor is further configured to determine the parameter by: determining whether the received periodic registration update timer value is greater than the predetermined maximum value for the RNA update timer; based on the received periodic registration update timer value being greater than the predetermined maximum value for the RNA update timer, determining the parameter to be equal to (the predetermined maximum value for the RNA update timer/the received periodic registration update timer value); and based on the received periodic registration update timer value being less than or equal to the predetermined maximum value for the RNA update timer, determining the parameter to be equal to ((the predetermined maximum value for the RNA update timer−the received periodic registration update timer value)/the predetermined maximum value for the RNA update timer).

According to one or more embodiments, a non-transitory computer-readable recording medium having recorded thereon instructions executable by at least one processor, for performing a method of configuring aperiodic radio access network (RAN) notification area (RNA) update timer based on a periodic registration update timer, the method includes: obtaining a periodic registration update timer value provided by a core network; and determining a RNA update timer value based on the obtained periodic registration update timer value such that the RNA update timer value is less than the obtained periodic registration update timer value and less than a predetermined maximum value for the RNA update timer.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIGS. 1A and 1B illustrate an O-RAN architecture in the related art;

FIG. 2 illustrates a RAN Intelligent Controller (RIC) architecture in the related art;

FIG. 3 illustrates a flowchart for a calculation of a t380DerivationAssistancevalue, in accordance with one or more embodiments;

FIG. 4 illustrates a call flow diagram for t380DerivationAssistancevalue adjustment from the near-real-time RIC, in accordance with one or more embodiments;

FIG. 5 illustrates a flowchart for a calculation of a T380 timer value, in accordance with one or more embodiments;

FIG. 6 illustrates a call flow diagram for T380 control from the near-real-time RIC, in accordance with one or more embodiments;

FIG. 7 illustrates a call flow diagram for deriving a T380 timer value based on continuous monitoring of all UE residence time in the RAN, in accordance with one or more embodiments;

FIG. 8 illustrates a call flow diagram for deriving a T380 timer value based on monitoring the inter packet arrival gap in the downlink direction, in accordance with one or more embodiments;

FIG. 9 is a diagram of an example environment in which systems and/or methods, described herein, may be implemented; and

FIG. 10 is a diagram of example components of a device according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments provide systems and methods for adjusting a periodic radio access network (RAN) notification area update timer based on a periodic registration area timer provided by the core network.

In the related art, the Access and Mobility Management Function (AMF) of the 5G core network sends RRC Inactive Assistance Information to the 5G radio access network (NG-RAN). In this regard, the AMF provides assistance information to the NG-RAN to assist the NG-RAN's decision as to whether a UE can be sent to the RRC inactive state. The RRC Inactive Assistance Information includes, among others, the registration area provided to the UE and a periodic registration update timer (T3512). A periodic registration update procedure is performed by the UE towards the core network for periodically notifying the availability of the UE to the network. The procedure is performed in the UE based on the periodic registration update timer (T3512), which is started in the 5GMM-REGISTERED mode when the 5GMM-CONNECTED mode is left. The value of the T3512 timer pursuant to the related art 3GPP standard may be as high as 320 hours.

Further, 3GPP provides that, when the UE transitions into the CM-CONNECTED state for communication with the core network while in the RRC Inactive state, the NG-RAN configures the UE with a periodic RAN Notification Area (RNA) Update timer (T380), which may be as high as 12 hours. Thus, the maximum value of the T3512 timer is much larger than that of the T380 timer.

Also, the T3512 timer is started in the UE only after UE enters CM-IDLE state. While in the RRC-Inactive state in the RAN, the UE will still be in the CM-CONNECTED state with the core network and hence the UE will not start the T3512 timer. Hence, the T380 timer may not be larger than T3512 timer in the UE.

Although the related art standards may provide that the Periodic Registration Update timer (T3512) is sent as assistance information from the core network to the RAN, the related art has no provision as to how the RAN is to use the T3512 timer for adjusting or configuring the T380 timer towards the UE. As described below, one or more example embodiments provide a method for configuring the T380 timer towards the UE based on the Periodic Registration Update timer (T3512) from the core network. An advantage of configuring the T380 timer according to one or more embodiments is that flexibility is provided to operators for optimizing the T380 timer based on the Periodic Registration Update Timer used in the core network to efficiently and accurately assure that the T380 timer is configured to be less than the T3512 timer.

The T380 timer may be provided to the UE from the RAN (e.g., base station, gNB-CU-CP, or ng-eNB-CU-CP) in an RRCRelease message in the following container:

| | |
|---|---|
| SuspendConfig ::= | SEQUENCE { |
| fullI-RNTI | I-RNTI-Value, |
| shortI-RNTI | ShortI-RNTI-Value, |
| ran-PagingCycle | PagingCycle, |
| ran-NotificationAreaInfo | RAN-NotificationAreaInfo |
| OPTIONAL, -- Need M | |
| t380 | PeriodicRNAU-TimerValue |
| OPTIONAL, -- Need R | |
| nextHopChainingCount | NextHopChainingCount, |
| ... | |
| } | |

According to one or more embodiments, a configuration parameter (referred to herein as t380DerivationAssitancevalue) is used to derive the T380 timer value. According to an example embodiment, t380DerivationAssitancevalue may be made available at the base station or the gNB-CU-CP/ng-eNB-CUP-CP as an O1 configuration/parameter. That is, this parameter may be configured in the CU-CP and/or updated/modified from the SMO over the O1 interface. This parameter represents the ratio of the T380 timer to the Periodic Registration Update (PRU) timer (T3512) value. Because the T380 timer value cannot be greater than the PRU timer value, the t380DerivationAssistancevalue will be a decimal in the range of 0 to 1. The UE is provided the T380 timer value using, for example, the following calculation:

T380=t380DerivationAssistancevalue*periodicRegistrationUpdateTimer

According to one or more other embodiments, t380DerivationAssitancevalue is derived or determined at the near-real-time RAN Intelligent Controller (RIC) of an Open RAN (O-RAN) architecture. In the O-RAN architecture, the RAN functions are disaggregated into a centralized unit (CU), a distributed unit (DU), and a radio unit (RU). The CU is a logical node for hosting Radio Resource Control (RRC), Service Data Adaptation Protocol (SDAP), and/or Packet Data Convergence Protocol (PDCP) sublayers of the RAN. The CU can be further split into CU-CP hosting RRC and CU-UP hosting SDAP and PDCP. The DU is a logical node hosting Radio Link Control (RLC), Media Access Control (MAC), and Physical (PHY) sublayers of the RAN. The RU is a physical node that converts radio signals from antennas to digital signals that can be transmitted over the FrontHaul to a DU. Because these entities have open protocols and interfaces between them, they can be developed by different vendors.

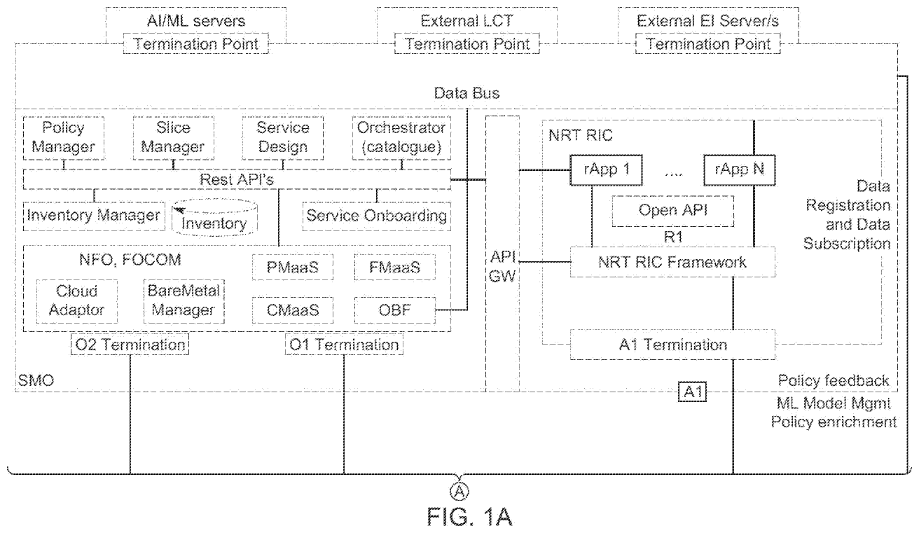

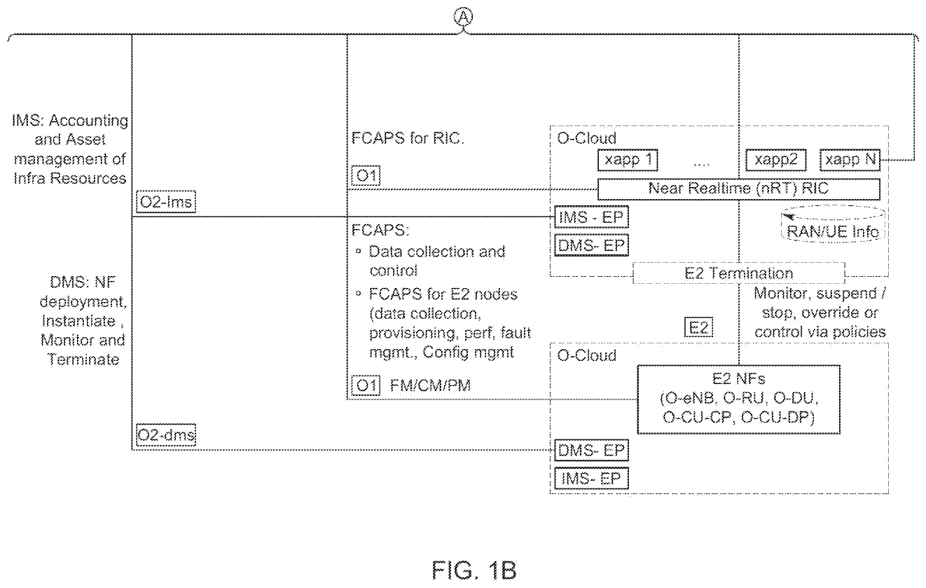

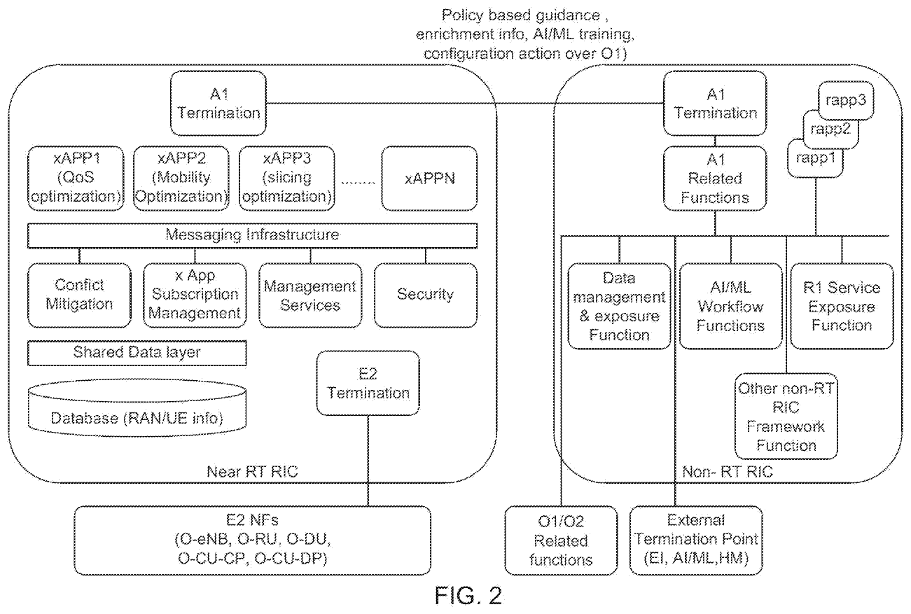

FIGS. 1A and 1B illustrate a related art O-RAN architecture, and FIG. 2 illustrates a related art RAN Intelligent Controller (RIC) architecture. Referring to FIGS. 1A, 1B, and 2, RAN functions in the O-RAN architecture are controlled and optimized by a RIC. The RIC is a software-defined component that implements modular applications to facilitate the multivendor operability required in the O-RAN system, as well as to automate and optimize RAN operations. The RIC is divided into two types: a non-real-time RIC (NRT RIC) and a near-real-time RIC (nRT RIC).

The non-real-time RIC is the control point of a non-real-time control loop and operates on a timescale greater than 1 second within the Service Management and Orchestration (SMO) framework. Its functionalities are implemented through modular applications called rApps (rApp 1, . . . , rApp N in FIG. 1A), and include: providing policy based guidance and enrichment across the Al interface, which is the interface that enables communication between the non-real-time RIC and the near-real-time RIC; performing data analytics; Artificial Intelligence/Machine Learning (AI/ML) training and inference for RAN optimization; and/or recommending configuration management actions over the O1 interface, which is the interface that connects the SMO to RAN managed elements (e.g., near-real-time RIC, O-RAN Centralized Unit (O-CU), O-RAN Distributed Unit (O-DU), etc.).

The near-real-time RIC operates on a timescale between 10 milliseconds and 1 second and connects to the O-DU, O-CU (disaggregated into the O-CU control plane (O-CU-CP) and the O-CU user plane (O-CU-UP)), and an open evolved NodeB (O-eNB) via the E2 interface. The near-real-time RIC uses the E2 interface to control the underlying RAN elements (E2 nodes/network functions (NFs)) over a near-real-time control loop. The near-real-time RIC monitors, suspends/stops, overrides, and controls the E2 nodes (O-CU, 0-DU, and O-eNB) via policies. For example, the near-real-time sets policy parameters on activated functions of the E2 nodes. Further, the near-real-time RIC hosts xApps to implement functions such as quality of service (QoS) optimization, mobility optimization, slicing optimization, interference mitigation, load balancing, security, etc. The two types of RICs work together to optimize the O-RAN. For example, the non-real-time RIC provides, over the Al interface, the policies, data, and AI/ML models enforced and used by the near-real-time RIC for RAN optimization, and the near-real-time returns policy feedback (i.e., how the policy set by the non-real-time RIC works).

The SMO framework, within which the non-real-time RIC is located, manages and orchestrates RAN elements. Specifically, the SMO manages and orchestrates what is referred to as the O-Ran Cloud (O-Cloud). The O-Cloud is a collection of physical RAN nodes that host the RICs, O-CUs, and O-DUs, the supporting software components (e.g., the operating systems and runtime environments), and the SMO itself. In other words, the SMO manages the O-Cloud from within. The O2 interface is the interface between the SMO and the O-Cloud it resides in. Through the O2 interface, the SMO provides infrastructure management services (IMS) and deployment management services (DMS).

As set forth above, in various example embodiments, the T380 derivation assistance value (referred to by way of example as t380DerivationAssistancevalue) is determined or calculated at the gNB-CU-CP/ng-eNB-CUP-CP or at the near-real-time RIC.

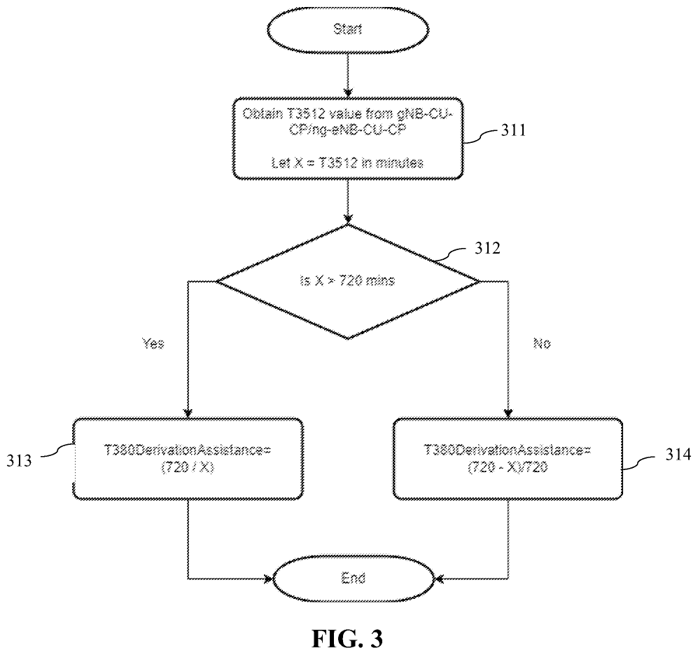

FIG. 3 illustrates a flowchart for a calculation of a T380 derivation assistance value for a T380 timer, in accordance with one or more embodiments. According to an example embodiment, an xApp hosted in the near-real-time RIC calculates t380DerivationAssistancevalue using a T3512 value. The T3512 value may be obtained from the CU-CP (e.g., gNB-CU-CP or ng-eNB-CU-CP), which receives the value from the core network (e.g., AMF) via the RRC Inactive Assistance Information. As set forth above, t380DerivationAssistancevalue may be a decimal value in the range of 0 to 1, and is multiplied by the T3512 value to obtain T380. However, the maximum T3512 value (320 hours) is substantially higher than the maximum T380 value (12 hours). Therefore, in accordance with example embodiments, the xApp may include logic that implements various rules to ensure that t380DerivationAssistancevalue does not result in a T380 value that exceeds the maximum.

Referring to FIG. 3, at step 311, a T3512 value is obtained from gNB-CU-CP/ng-eNB-CU-CP, with a variable x set to the T3512 in minutes. At step 312, it is determined whether x is greater than the maximum value for T380 (720 minutes). If x is greater than 720 minutes, then t380DerivationAssistancevalue is set to 720/x (step 313). If x is less than or equal to 720 minutes, then t380DerivationAssistancevalue is set to (720−x)/720 (step 314). The above calculation is only an example embodiment. Other mechanisms to derive a t380DerivationAssistancevalue that is in a range of 0 to 1 and provides a T380 that is not greater than the maximum may be used.

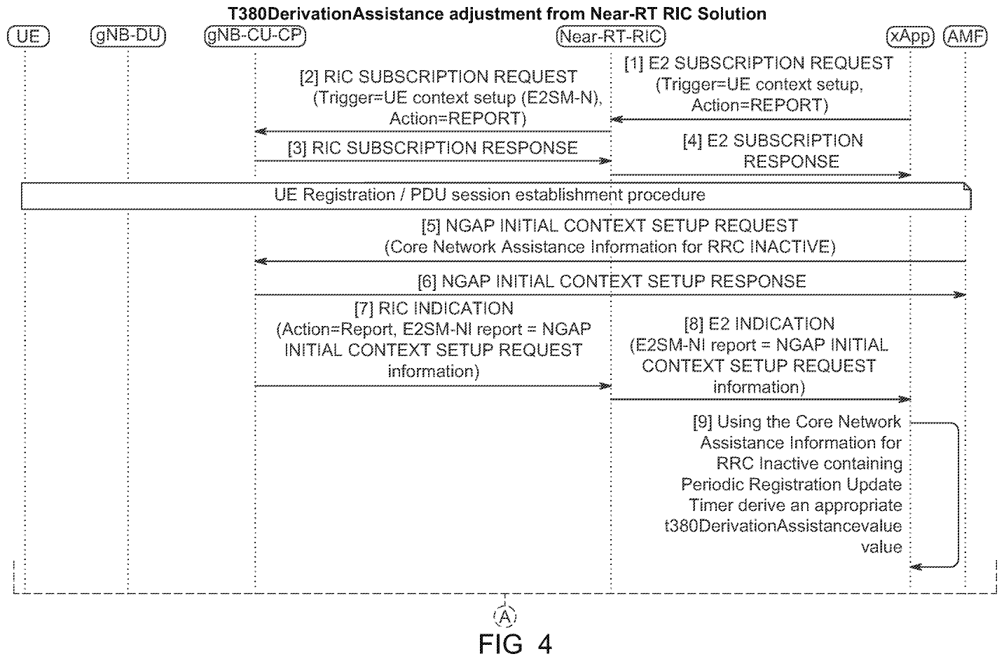

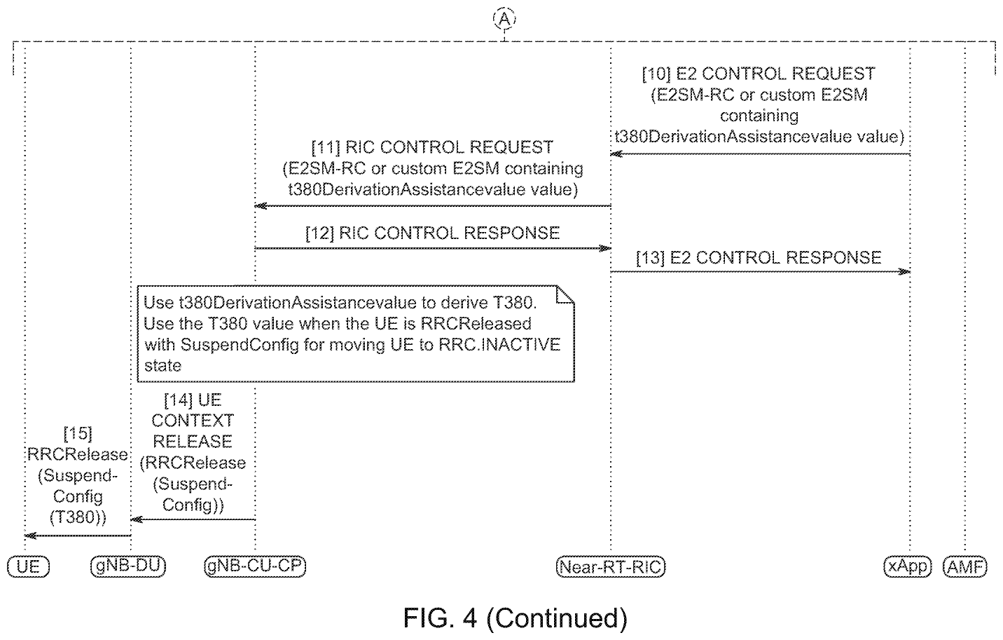

FIG. 4 illustrates a call flow diagram for t380DerivationAssistancevalue control from near-real-time RIC, in accordance with one or more embodiments. In the present example embodiment, the xApp calculates the t380DerivationAssistancevalue (e.g., as described above with reference to FIG. 3), and provides the same to the gNB-CU-CP/ng-eNB-CU-CP (e.g., via the E2 interface through an E2 CONTROL REQUEST). In this case, the CU-CP derives or configures the T380 value using t380DerivationAssistancevalue (e.g., T380=T3512*t380DerivationAssistancevalue).

Referring to FIG. 4, in steps [1] to [8], the T3512 timer value is provided to the xApp from the CU-CP. Specifically, the xApp transmits an E2 Subscription Request to the CU-CP via the near-real-time RIC (steps [1] and [2]), and the CU-CP sends back an acknowledgment or confirmation of the subscription via a Subscription Response (steps [3] and [4]). Further, RRC Inactive Assistance Information is received and acknowledged by the CU-CP from the core network (AMF) based on an NGAP INITIAL CONTEXT SETUP REQUEST and RESPONSE at steps [5] and [6]. The assistance information includes the T3512 timer value, which is then provided by the CU-CP to the xApp in steps [7] and [8].

According to example embodiments, the xApp derives t380DerivationAssistancevalue using the core network assistance information for RRC Inactive (which includes the T3512 value) as an input at step [9]. An algorithm for deriving the T380 timer value is shown in FIG. 3, according to one or more embodiments.

At step [10], the xApp sends an E2 control request to the near-real-time RIC. The E2 control request may include an O-RAN E2 service model (e.g., E2SM-RC) or a custom E2SM including the t380DerivationAssistancevalue. As described in step [11], a RIC control request, which includes an E2SM-RC or a custom E2SM including a t380DerivationAssistancevalue, may be sent from the near-real-time RIC to the gNB-CU-CP or the ng-eNB-CU-CP. A RIC control response (step [12] of FIG. 4) is then sent to the near-real-time RIC and the E2 control response is sent to the xApp (step [13] of FIG. 4). The t380DerivationAssistancevalue is then used by the CU-CP to derive the T380 timer value. For example, the gNB-CU-CP/ng-eNB-CU-CP may calculate the T380 value as:

T380=t380DerivationAssistancevalue*periodicRegistrationUpdateTimer and round up and/or down to the nearest T380 value options defined in 3GPP TS 38.331.

According to embodiments, the T380 timer value may be used when the UE is RRCReleased with SuspendConfig (step [14] of FIG. 4) for moving a UE to an RRC-Inactive state (step [15] of FIG. 4).

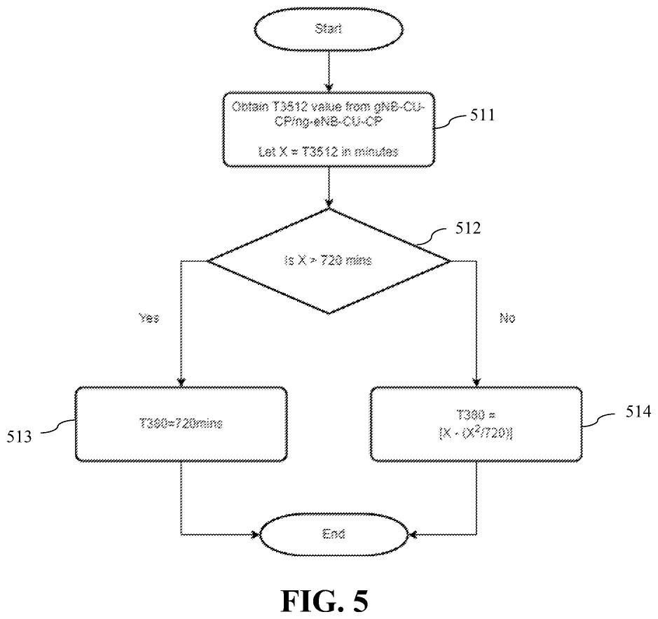

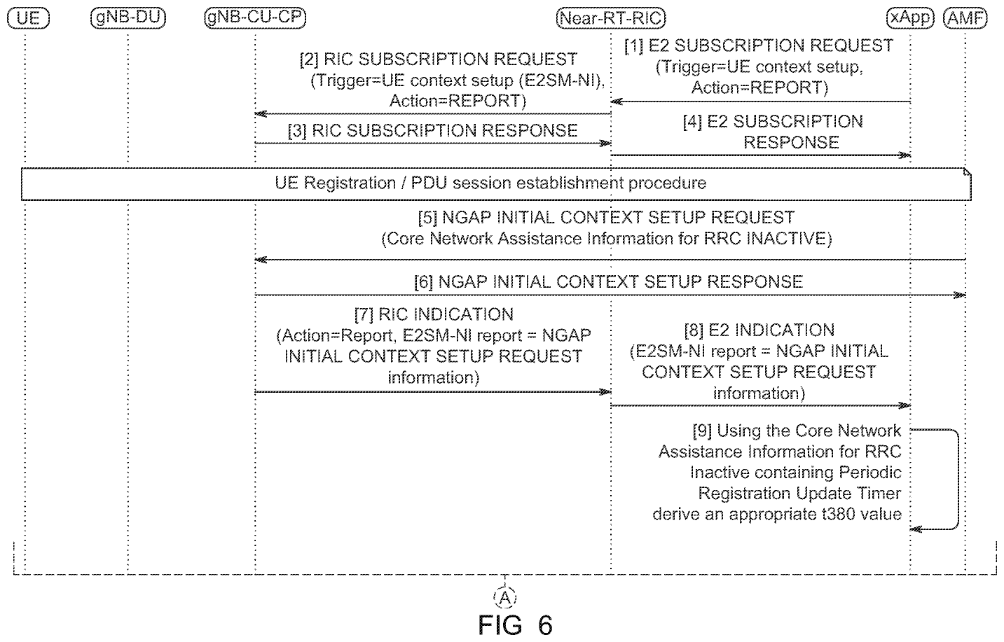

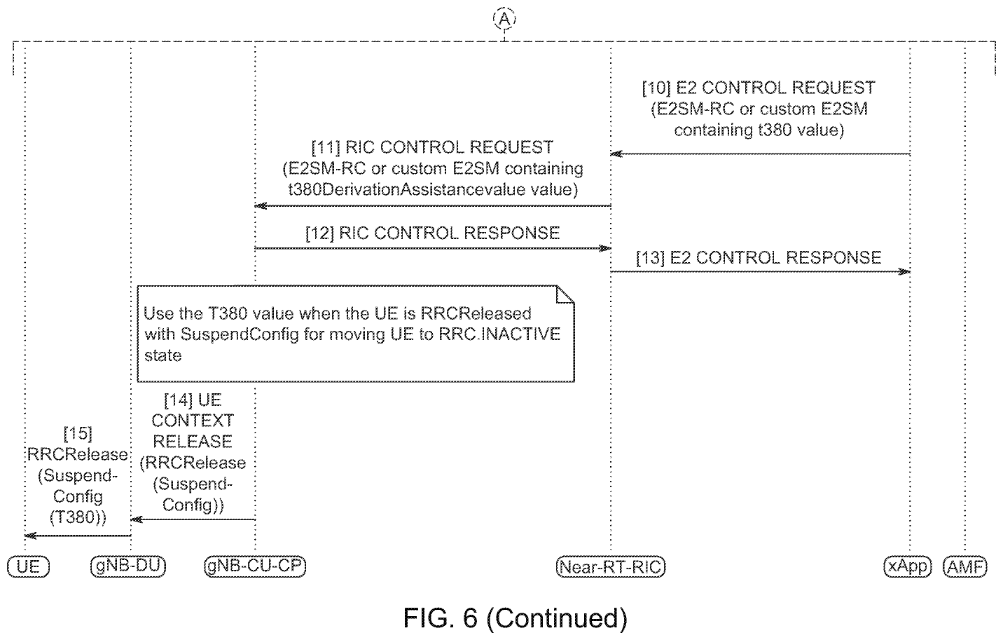

While in the above-described embodiment, the T380 timer value is calculated or derived at the CU-CP based on the t380DerivationAssistancevalue provided by the xApp, it is understood that one or more other embodiments are not limited thereto. For example, according to another embodiment, the xApp itself may derive the T380 timer value and provide the same to the CU-CP, as described below with reference to FIGS. 5 and 6.

FIG. 5 illustrates a flowchart for a calculation of a T380 timer value at the near-real-time RIC, in accordance with one or more embodiments. As illustrated in FIG. 5, according to an embodiment, the xApp may derive a T380 timer value using the T3512 value as input. At step 511, the T3512 timer value may be obtained from the gNB-CU-CP/ng-eNB-CU-CP and a variable X may be set to the T3512 timer value in minutes. At step 512, it is determined whether X is greater than 720 minutes. If X is greater than (or equal to) 720 minutes, then the T380 timer value may be set to 720 minutes (step 513). If X is less than 720 minutes (step 514), then the T380 timer value may be set to:

$$T 380 = \frac{720 - X}{720} * X = \frac{720 X - {X}^{2}}{720} = X - \frac{{X}^{2}}{720}$$

FIG. 6 illustrates a call flow diagram for T380 control from the near-real-time RIC, in accordance with one or more embodiments. Unlike the embodiment of FIG. 4, in which the CU-CP is provided with the t380DerivationAssistancevalue and derives the T380 timer value accordingly, the T380 timer value is derived in the near-real-time RIC in the present example embodiment. Thus, as illustrated in FIG. 6, the xApp updates or configures the T380 timer value to the gNB-CU-CP/ng-eNB-CU-CP through an E2 CONTROL REQUEST.

Referring to FIG. 6, as described in steps [1] to [8], the T3512 timer value is provided to the xApp. This process is similar to that described above with reference to FIG. 4, and a redundant description thereof is omitted below.

Next, in step [9], the xApp derives an appropriate T380 timer value using core network assistance information for RRC Inactive containing a periodic registration updated timer. The T380 timer value may be derived according to the process described in FIG. 5, though it is understood that one or more other embodiments are not limited thereto and the T380 timer value may be derived using other rules to ensure that the T380 timer is less than both its maximum allowed value and the value of the T3512 timer. For example, in another embodiment, the xApp may calculate the t380DerivationAssistancevalue (e.g., as described above with reference to FIG. 3) and may derive the T380 timer value accordingly (e.g., T380=t380DerivationAssistancevalue*T3512).

At step [10], the xApp sends an E2 control request to the near-real-time RIC. The E2 control request may include an O-RAN E2 service model (e.g., E2SM-RC) or a custom E2SM including the T380 timer value. As described in step [11], a RIC control request, which includes an E2SM-RC or a custom E2SM including the T380 timer value, may be sent from the near-real-time RIC to the gNB-CU-CP. A RIC control response (step [12] of FIG. 6) is then sent to the near-real-time RIC and the E2 control response is sent to the xApp (step [13] of FIG. 6). According to embodiments, the T380 timer value may be used when the UE is RRCReleased with SuspendConfig (step [14] of FIG. 6) for moving the UE to an RRC-Inactive state (step [15] of FIG. 6).

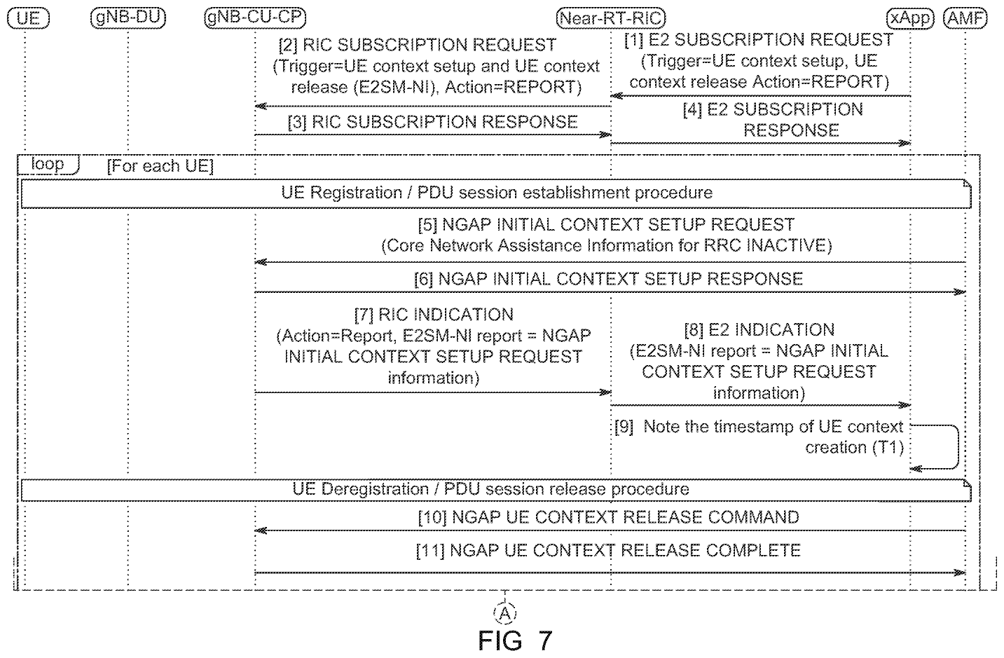

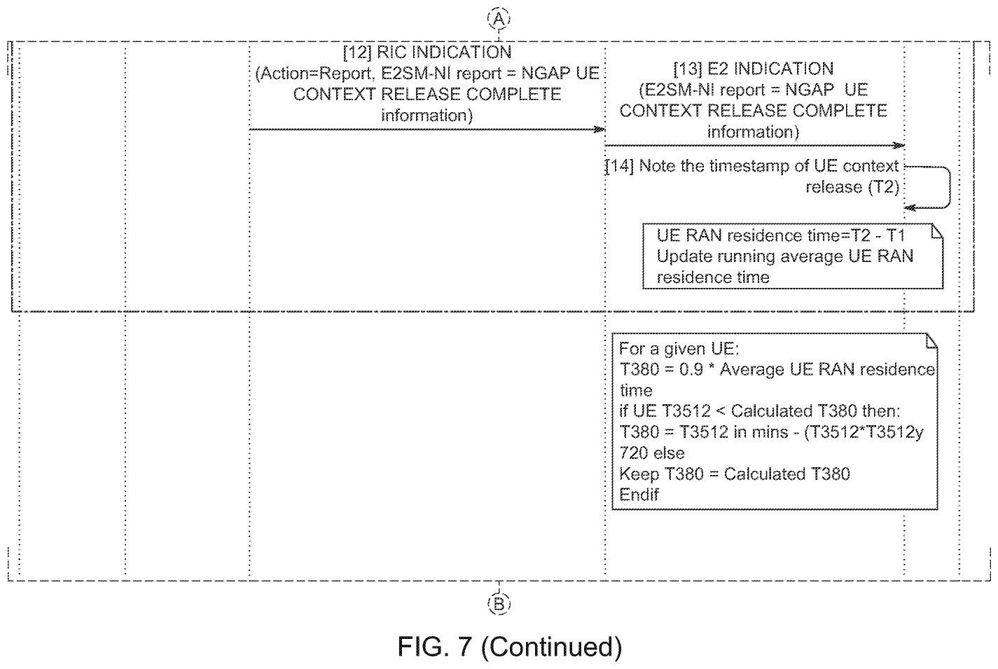

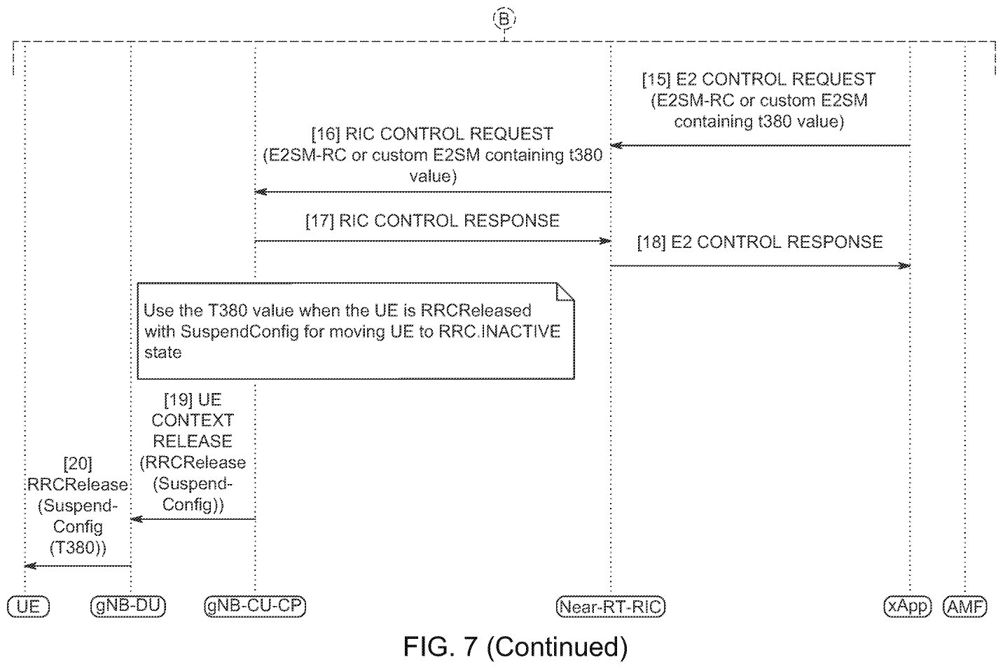

According to another embodiment, the T380 value can be derived by the xApp based on continuous monitoring of all UE residence time in the RAN, as described below with reference to FIG. 7.

FIG. 7 illustrates a call flow diagram for deriving a T380 timer value based on continuous monitoring of all UE residence time in the RAN, in accordance with one or more embodiments.

Referring to FIG. 7, as described in steps [1] to [8], NGAP INITIAL CONTEXT SETUP REQUEST is provided to the xApp. This process is similar to that described above with reference to FIG. 4, and a redundant description thereof is omitted below.

As illustrated at steps [9] and [14], the timestamp of UE context creation is determined at times T1 and T2, respectively, and is used to update a running average of UE RAN residence time. For a given UE, T380 may be calculated at the xApp as a predetermined decimal value (e.g., 0.9) multiplied by the running average. If the calculated T380 is greater than T3512, then T380 is determined to be equal to T3512−(T3512*T3512)/720. Otherwise, the calculated T380 is maintained.

The average RAN residence time can also be calculated per UE category or per slice (S-NSSAI). The T380 value for a given UE can be provided based on the UE category or S-NSSAI the UE is using. The xApp may know the UE category and/or S-NSSAI that the UE is using based on the INITIAL CONTEXT SETUP REQUEST message copy received over the E2 interface. For example, the following information is included in the INITIAL CONTEXT SETUP REQUEST message:

| | | | | |
|---|---|---|---|---|
| >>S-NSSAI | M | 9.3.1.24 | — | |
| UE Radio Capability | O | 9.3.1.74 | YES | ignore |

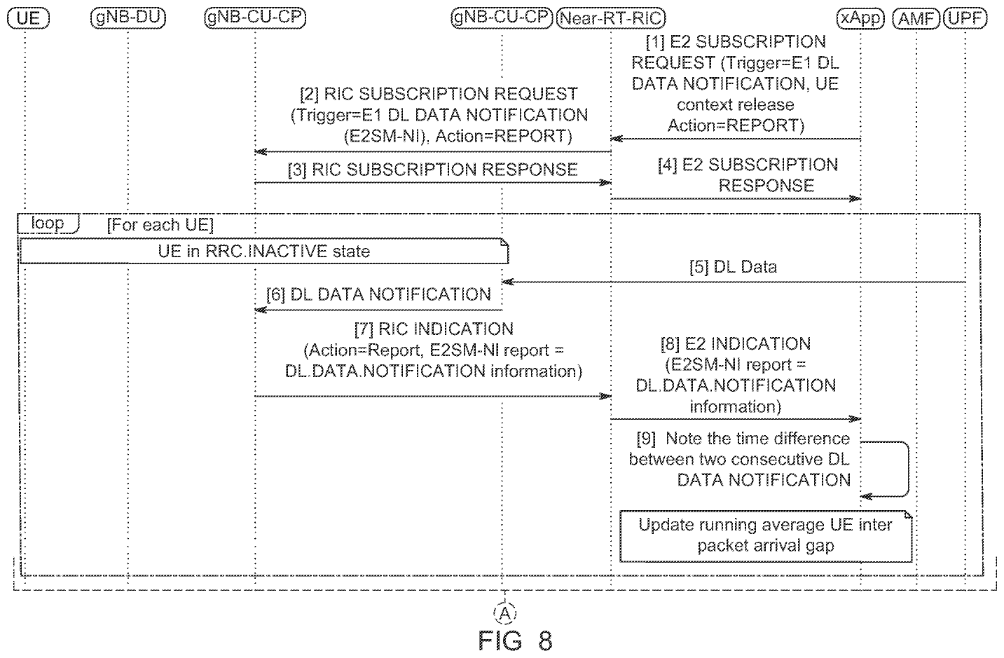

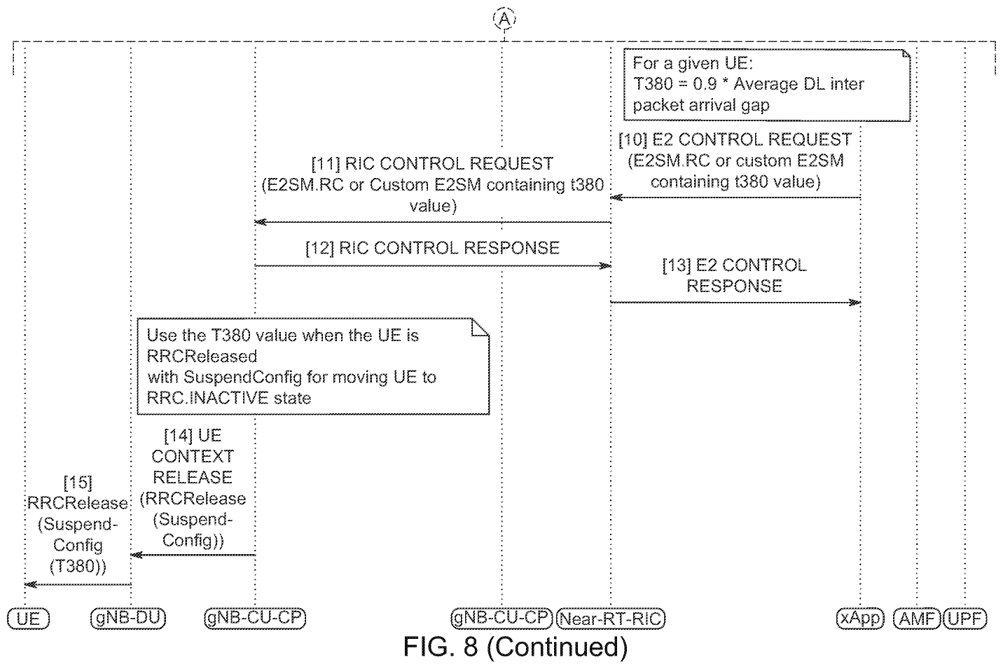

According to still another example embodiment, the T380 value may be optimized by an xApp by monitoring the inter packet arrival gap in the downlink direction, for UEs that are in RRC-Inactive state, as described below with reference to FIG. 8.

FIG. 8 illustrates a call flow diagram for deriving a T380 timer value based on monitoring the inter packet arrival gap in the downlink direction, in accordance with one or more embodiments. For example, the T380 value can be optimized by an xApp by monitoring the inter packet arrival gap in the downlink direction, for UEs that are in RRC-Inactive state. When the UE goes into RRC-Inactive state, the initial T380 value may be given to UE using, for example, one of the methods described above. The T380 may be further tuned and/or optimized by the process illustrated in FIG. 8.

UEs that are in RRC-Inactive state may have their user plane context suspended in the CU-UP as defined in 3GPP. When the user plane context is suspended, the arrival of any downlink packet for the UE from the core network (e.g., UPF) may trigger a DL DATA NOTIFICATION from the CU-UP to the CU-CP over E1 interface. The CU-CP may then trigger RAN initiated PAGING towards the UE to resume the UE context. By tuning the T380 timer to a value less than (e.g., 1 or 2 seconds less) the downlink inter packet arrival gap, it is ensured that UE resumes the context in time and avoids RAN initiated paging when the packet actually arrives.

The tuned T380 value may be calculated per UE category or per slice using network slice selection assistance information (S-NSSAI), instead of calculating a common average across all UEs. The T380 value recommendation for a given UE may be provided based on the UE category or S-NSSAI the UE is using. The xApp may know the UE category and/or S-NSSAI the UE is using based on the INITIAL CONTEXT SETUP REQUEST message copy received over the E2 interface.

While embodiments described above are with respect to a RAN architecture in which the base station functionality is disaggregated and the T380 timer value is determined by or provided to the CU-CP, it is understood that one or more other embodiments are not limited thereto and, for example, may be implemented in or with respect to a base station that is not disaggregated or virtualized.

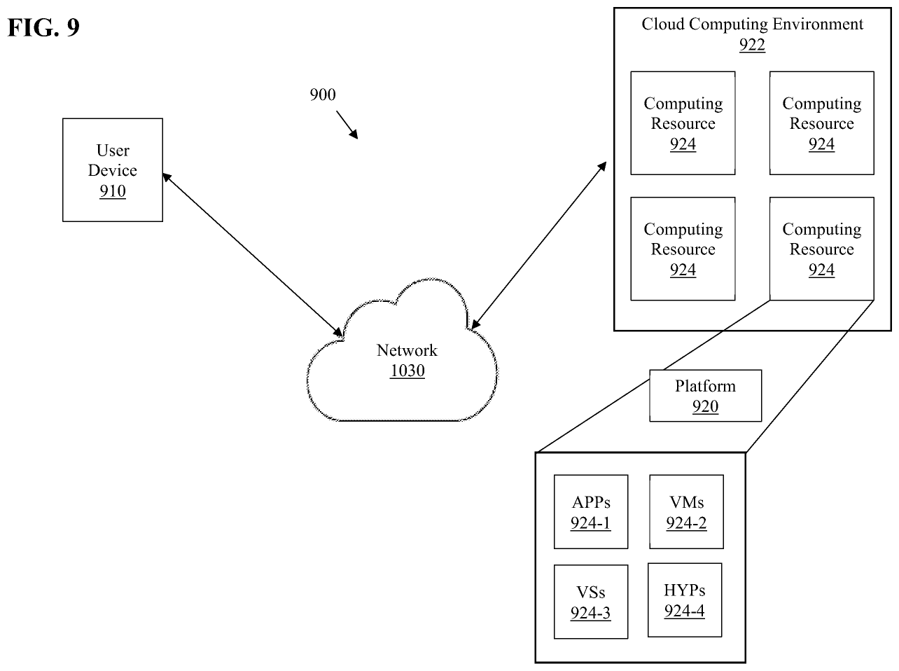

FIG. 9 is a diagram of an example environment 900 in which systems and/or methods, described herein, may be implemented. As shown in FIG. 9, environment 900 may include a user device 910, a platform 920, and a network 930. Devices of environment 900 may interconnect via wired connections, wireless connections, or a combination of wired and wireless connections. In embodiments, any of the functions and operations described with reference to FIGS. 3 through 5 above may be performed by any combination of elements illustrated in FIG. 9.

User device 910 includes one or more devices capable of receiving, generating, storing, processing, and/or providing information associated with platform 920. For example, user device 910 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 910 may receive information from and/or transmit information to platform 920.

Platform 920 includes one or more devices capable of receiving, generating, storing, processing, and/or providing information. In some implementations, platform 920 may include a cloud server or a group of cloud servers. In some implementations, platform 920 may be designed to be modular such that certain software components may be swapped in or out depending on a particular need. As such, platform 920 may be easily and/or quickly reconfigured for different uses.

In some implementations, as shown, platform 920 may be hosted in cloud computing environment 922. Notably, while implementations described herein describe platform 920 as being hosted in cloud computing environment 922, in some implementations, platform 920 may not be cloud-based (i.e., may be implemented outside of a cloud computing environment) or may be partially cloud-based.

Cloud computing environment 922 includes an environment that hosts platform 920. Cloud computing environment 922 may provide computation, software, data access, storage, etc., services that do not require end-user (e.g., user device 910) knowledge of a physical location and configuration of system(s) and/or device(s) that hosts platform 920. As shown, cloud computing environment 922 may include a group of computing resources 924 (referred to collectively as “computing resources 924” and individually as “computing resource 924”).

Computing resource 924 includes one or more personal computers, a cluster of computing devices, workstation computers, server devices, or other types of computation and/or communication devices. In some implementations, computing resource 924 may host platform 920. The cloud resources may include compute instances executing in computing resource 924, storage devices provided in computing resource 924, data transfer devices provided by computing resource 924, etc. In some implementations, computing resource 924 may communicate with other computing resources 924 via wired connections, wireless connections, or a combination of wired and wireless connections.

As further shown in FIG. 9, computing resource 924 includes a group of cloud resources, such as one or more applications (“APPs”) 924-1, one or more virtual machines (“VMs”) 924-2, virtualized storage (“VSs”) 924-3, one or more hypervisors (“HYPs”) 924-4, or the like.

Application 924-1 includes one or more software applications that may be provided to or accessed by user device 910. Application 924-1 may eliminate a need to install and execute the software applications on user device 910. For example, application 924-1 may include software associated with platform 920 and/or any other software capable of being provided via cloud computing environment 922. In some implementations, one application 924-1 may send/receive information to/from one or more other applications 924-1, via virtual machine 924-2.

Virtual machine 924-2 includes a software implementation of a machine (e.g., a computer) that executes programs like a physical machine. Virtual machine 924-2 may be either a system virtual machine or a process virtual machine, depending upon use and degree of correspondence to any real machine by virtual machine 924-2. A system virtual machine may provide a complete system platform that supports execution of a complete operating system (“OS”). A process virtual machine may execute a single program, and may support a single process. In some implementations, virtual machine 924-2 may execute on behalf of a user (e.g., user device 910), and may manage infrastructure of cloud computing environment 922, such as data management, synchronization, or long-duration data transfers.

Virtualized storage 924-3 includes one or more storage systems and/or one or more devices that use virtualization techniques within the storage systems or devices of computing resource 924. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 924-4 may provide hardware virtualization techniques that allow multiple operating systems (e.g., “guest operating systems”) to execute concurrently on a host computer, such as computing resource 924. Hypervisor 924-4 may present a virtual operating platform to the guest operating systems, and may manage the execution of the guest operating systems. Multiple instances of a variety of operating systems may share virtualized hardware resources.

Network 930 includes one or more wired and/or wireless networks. For example, network 930 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 9 are provided as an example. In practice, there may be additional devices and/or networks, fewer devices and/or networks, different devices and/or networks, or differently arranged devices and/or networks than those shown in FIG. 9. Furthermore, two or more devices shown in FIG. 9 may be implemented within a single device, or a single device shown in FIG. 9 may be implemented as multiple, distributed devices. Additionally, or alternatively, a set of devices (e.g., one or more devices) of environment 900 may perform one or more functions described as being performed by another set of devices of environment 900.

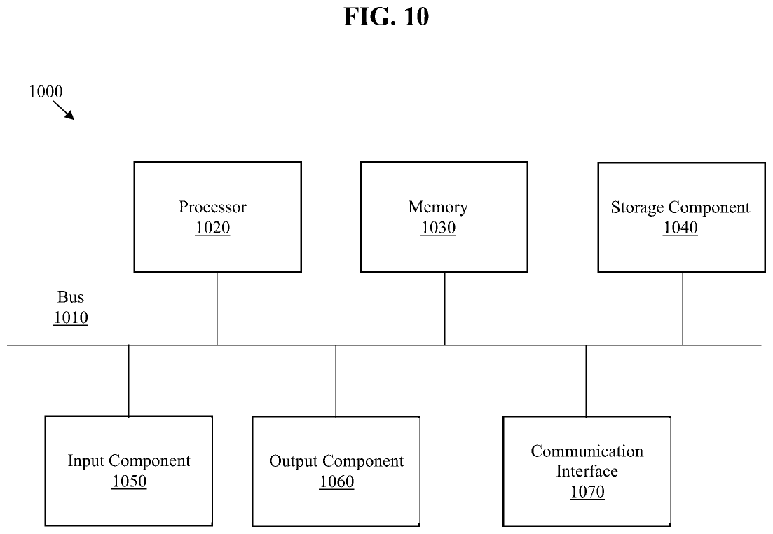

FIG. 10 is a diagram of example components of a device 1000. Device 1000 may correspond to user device 910 and/or platform 920. As shown in FIG. 10, device 1000 may include a bus 1010, a processor 1020, a memory 1030, a storage component 1040, an input component 1050, an output component 1060, and a communication interface 1070.

Bus 1010 includes a component that permits communication among the components of device 1000. Processor 1020 may be implemented in hardware, firmware, or a combination of hardware and software. Processor 1020 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 1020 includes one or more processors capable of being programmed to perform a function. Memory 1030 includes a random access memory (RAM), a read only memory (ROM), and/or another type of dynamic or static storage device (e.g., a flash memory, a magnetic memory, and/or an optical memory) that stores information and/or instructions for use by processor 1020.

Storage component 1040 stores information and/or software related to the operation and use of device 1000. For example, storage component 1040 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 1050 includes a component that permits device 1000 to receive information, such as via user input (e.g., a touch screen display, a keyboard, a keypad, a mouse, a button, a switch, and/or a microphone). Additionally, or alternatively, input component 1050 may include a sensor for sensing information (e.g., a global positioning system (GPS) component, an accelerometer, a gyroscope, and/or an actuator). Output component 1060 includes a component that provides output information from device 1000 (e.g., a display, a speaker, and/or one or more light-emitting diodes (LEDs)).

Communication interface 1070 includes a transceiver-like component (e.g., a transceiver and/or a separate receiver and transmitter) that enables device 1000 to communicate with other devices, such as via a wired connection, a wireless connection, or a combination of wired and wireless connections. Communication interface 1070 may permit device 1000 to receive information from another device and/or provide information to another device. For example, communication interface 1070 may include an Ethernet interface, an optical interface, a coaxial interface, an infrared interface, a radio frequency (RF) interface, a universal serial bus (USB) interface, a Wi-Fi interface, a cellular network interface, or the like.

Device 1000 may perform one or more processes described herein. Device 1000 may perform these processes in response to processor 1020 executing software instructions stored by a non-transitory computer-readable medium, such as memory 1030 and/or storage component 1040. A computer-readable medium is defined herein as a non-transitory memory device. A memory device includes memory space within a single physical storage device or memory space spread across multiple physical storage devices.

Software instructions may be read into memory 1030 and/or storage component 1040 from another computer-readable medium or from another device via communication interface 1070. When executed, software instructions stored in memory 1030 and/or storage component 1040 may cause processor 1020 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 10 are provided as an example. In practice, device 1000 may include additional components, fewer components, different components, or differently arranged components than those shown in FIG. 10. Additionally, or alternatively, a set of components (e.g., one or more components) of device 1000 may perform one or more functions described as being performed by another set of components of device 1000.

In embodiments, any one of the operations or processes of FIGS. 3 through 8 may be implemented by or using any one of the elements illustrated in FIGS. 9 and 10.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method, performed by at least one processor, for configuring a periodic radio access network (RAN) notification area (RNA) update timer based on a periodic registration update timer, the method comprising:
obtaining a periodic registration update timer value provided by a core network; and
determining a RNA update timer value based on the obtained periodic registration update timer value such that the RNA update timer value is less than the obtained periodic registration update timer value and less than a predetermined maximum value for the RNA update timer.

2. The method of claim 1, wherein the determining the RNA update timer value comprises:
determining a parameter based on the periodic registration update timer; and
determining the RNA update timer value based on the parameter and the periodic registration update timer value.

3. The method of claim 2, wherein the determining the RNA update timer value further comprises configuring and/or updating the parameter via an O1 interface between a Service Management and Orchestration (SMO) framework and a centralized unit of a radio access network (RAN).

4. The method of claim 2, wherein:
the determining the parameter comprises:
receiving, by an xApp of a near-real-time RAN Intelligent Controller (RIC), the periodic registration update timer value; and
determining, by the xApp, the parameter based on the received periodic registration update timer value,
wherein the determining the RNA update timer value based on the parameter and the periodic registration update timer value comprises:
receiving, by a centralized unit of a RAN, the parameter from the near-real-time RIC over an E2 interface, and
determining, by the centralized unit, the RNA update timer based on the parameter and the periodic registration update timer value.

5. The method as claimed in claim 4, wherein the determining the parameter comprises:
determining whether the received periodic registration update timer value is greater than the predetermined maximum value for the RNA update timer;
based on the received periodic registration update timer value being greater than the predetermined maximum value for the RNA update timer, determining the parameter to be equal to (the predetermined maximum value for the RNA update timer/the received periodic registration update timer value); and
based on the received periodic registration update timer value being less than or equal to the predetermined maximum value for the RNA update timer, determining the parameter to be equal to ((the predetermined maximum value for the RNA update timer−the received periodic registration update timer value)/the predetermined maximum value for the RNA update timer).

6. The method as claimed in claim 4, wherein the determining, by the centralized unit, the RNA update timer value based on the parameter and the periodic registration update timer value comprises determining the RNA update timer value to be equal to (the parameter*the periodic registration update timer value) and rounding it off to a nearest RNA update timer value enumeration as specified in 3GPP specification.

7. The method as claimed in claim 1, wherein the RNA update timer value is determined by an xApp of a near-real-time RAN Intelligent Controller (RIC) using the periodic registration update timer value, and is provided to a centralized unit of a RAN over an E2 interface.

8. The method as claimed in claim 7, wherein the determining the RNA update timer value comprises:
determining whether the periodic registration update timer value is greater than the predetermined maximum value for the RNA update timer;
based on the periodic registration update timer value being greater than the predetermined maximum value for the RNA update timer, determining the RNA update timer value to be equal to the predetermined maximum value for the RNA update timer; and
based on the periodic registration update timer value being less than or equal to the predetermined maximum value for the RNA update timer, determining the RNA update timer value to be equal to (the periodic registration update timer value−(the periodic registration update timer value squared/the predetermined maximum value for the RNA update timer)).

9. The method as claimed in claim 7, wherein the determining the RNA update timer value comprises determining, by the xApp, the RNA update timer value based on an average user equipment (UE) residence time in the RAN.

10. The method as claimed in claim 9, wherein an average UE residence time in RAN is calculated in the xApp based on a UE admit time and a UE release time, averaged across a plurality of UEs.

11. The method as claimed in claim 10, wherein the xApp determines the UE admit time and the UE release time based on the UE admit and release events notified by the centralized unit (over E2).

12. The method as claimed in claim 7, wherein the determining the RNA update timer value comprises determining, by the xApp, the RNA update timer value based on an average downlink inter packet arrival gap in RRC-Inactive state.

13. The method as claimed in claim 12 wherein the xApp determines the average downlink inter packet arrival gap based on an average time difference between two downlink data indications received for the UE.

14. The method as claimed in claim 13 wherein an arrival of downlink data indication at the centralized unit (CU) is indicated to the xApp through the E2 interface.

15. An apparatus for configuring a periodic radio access network (RAN) notification area (RNA) update timer based on a periodic registration update timer, the apparatus comprising:
a memory storing instructions; and
at least one processor configured to execute the instructions to:
obtain a periodic registration update timer value provided by a core network; and
determine a RNA update timer value based on the obtained periodic registration update timer value such that the RNA update timer value is less than the obtained periodic registration update timer value and less than a predetermined maximum value for the RNA update timer.

16. The apparatus as claimed in claim 15, wherein the at least one processor is further configured to:
determine a parameter based on the periodic registration update timer; and
determine the RNA update timer value based on the parameter and the periodic registration update timer value.

17. The apparatus as claimed in claim 16, wherein the at least one processor is further configured to determine the RNA update timer value further by configuring and/or updating the parameter via an O1 interface between a Service Management and Orchestration (SMO) framework and a centralized unit of a radio access network (RAN).

18. The apparatus as claimed in claim 16, wherein the at least one processor is further configured to determine the parameter by:
receiving, by an xApp of a near-real-time RAN Intelligent Controller (RIC), the periodic registration update timer value, and
determining, by the xApp, the parameter based on the received periodic registration update timer value; and
the determining the RNA update timer value based on the parameter and the periodic registration update timer value comprises:
receiving, by a centralized unit of a RAN, the parameter from the near-real-time RIC over an E2 interface, and
determining, by the centralized unit, the RNA update timer based on the parameter and the periodic registration update timer value.

19. The apparatus as claimed in claim 18, wherein the at least one processor is further configured to determine the parameter by:
determining whether the received periodic registration update timer value is greater than the predetermined maximum value for the RNA update timer;
based on the received periodic registration update timer value being greater than the predetermined maximum value for the RNA update timer, determining the parameter to be equal to (the predetermined maximum value for the RNA update timer/the received periodic registration update timer value); and
based on the received periodic registration update timer value being less than or equal to the predetermined maximum value for the RNA update timer, determining the parameter to be equal to ((the predetermined maximum value for the RNA update timer−the received periodic registration update timer value)/the predetermined maximum value for the RNA update timer).

20. A non-transitory computer-readable recording medium having recorded thereon instructions executable by at least one processor, for performing a method of configuring a periodic radio access network (RAN) notification area (RNA) update timer based on a periodic registration update timer, the method comprising:
obtaining a periodic registration update timer value provided by a core network; and
determining a RNA update timer value based on the obtained periodic registration update timer value such that the RNA update timer value is less than the obtained periodic registration update timer value and less than a predetermined maximum value for the RNA update timer.
